(19) United States
(12) Patent Application Publication
(10) Pub. No.: US 2008/0103983 A1
(43) Pub. Date: May 1, 2008

(54) Method and Apparatus for Selling Used Contents

(75) Inventors: Jae-seok Jang, Seoul (KR); Seok-bin Im, Seoul (KR); In-Wook Seo, Seoul (KR)

Correspondence Address: INTELLECTUAL PROPERTY LAW GROUP LLP, 12 SOUTH FIRST STREET, SUITE 1205, SAN JOSE, CA, 95113, US

(73) Assignee: KTFREETEL Co., Ltd., Seoul (KR)

(21) Appl. No.: 11/722,876

(22) PCT Filed: Dec. 19, 2005
(86) PCT No.: PCT/KR05/04376

§ 371 Date: Jun. 26, 2007

(30) Foreign Application Priority Data
Jan. 28, 2005 (KR) 10-2005-0007923

(51) Int. Cl. H04L 9/00

(52) U.S. Cl. 705/75

(57) ABSTRACT

Disclosed herein is a method of reselling content in a used content server connected to a Digital Right Management (DRM) server for managing authentication information of the content of at least one computing device. The method includes the steps of receiving information of requesting the resale of the content from a first computing device; examining the authentication information of the content requested for the resale through the DRM server; registering the content for sale if the authentication information of the content is valid; receiving purchase request information of the registered content from a second computing device; requesting alteration of the authentication information of the content from the DRM server; receiving a response signal for the alteration of the authentication information of the content; and reselling the content to the second computing device.

### CROSS-REFERENCE TO RELATED APPLICATIONS

This application is U.S. National Phase application, under 35 U.S.C. § 371, of International Application PCT/KR2005/004376, with an international filing date of Dec. 19, 2005 and claims priority to Korean application no. 10-2005-0007923, filed Jan. 28, 2005, all which are hereby incorporated by reference.

### BACKGROUND OF THE INVENTION

1. Field of Invention

The present invention relates generally to a method and apparatus for selling used content.

2. Background Art

As the Internet environment develops, transactions for several types of virtual content including software are being actively conducted. Particularly, a user who has purchased digitized information directly from a seller by downloading without the use of a recording medium, illegally provides digitized information to another user or deletes the digitized information because there is rarely a method of legally selling or transferring digitized information to another user when it is determined that the role of the digitized information is exhausted.

In order to resolve such an inconvenience, some methods are disclosed in Korean Patent Application Nos. 10-2003-0010349 and 10-2003-001 1995.

They suggest a method of reusing digital information content contained in a CD-ROM or any other recording medium or a method of directly reusing digital information. However, since they are aimed to general content in which an original user's digital information, that is, specific user authentication information is not included, there is no method capable of restricting illegal copying or any unauthenticated use of the content.

### SUMMARY OF THE INVENTION

### Technical Problem

Accordingly, an object of the present invention is to provide a method and apparatus for selling used content.

Furthermore, another object of the present invention is to provide a method and apparatus for reselling authentication information for the use of content and the content including the authentication information using Digital Right Management (DRM).

### Technical Solution

In order to accomplish the above objects, the present invention can provide a method of reselling content in a used content server connected to a Digital Right Management (DRM) server for managing authentication information of content of at least one computing device, the method comprising the steps of receiving information of requesting resale of the content from a first computing device; examining authentication information of the content requested for resale through the DRM server; registering the content for sale if the authentication information of the content is valid; receiving purchase request information of the registered content from a second computing device; requesting alteration of the authentication information of the content to the DRM server; receiving a response signal for the alteration of the authentication information of the content from the DRM server, wherein the response signal for the alteration of the authentication information of the content is transmitted by the DRM server which requests deletion of the authentication information of the content to the first computing device after receiving a signal of requesting alteration of the authentication information of the content from the used content server and receives a response signal for the deletion of the authentication information of the content transmitted by the first computing device having received the request information; and reselling the content to the second computing device.

In a preferred embodiment, the resold content includes a Rights Object (RO) based on an Open Mobile Alliance (OMA) 2.0-based encryption method. Furthermore, the DRM server uses an OMA 2.0-based encryption method. Furthermore, the authentication information is RO information based on an OMA 2.0-based encryption method.

According to another aspect of the present invention, the present invention can provide a method of reselling content in a used content server connected to a DRM server for managing authentication information of content of at least one computing device, the method comprising the steps of receiving information of requesting resale of the content having use limitation from a first computing device; examining the authentication information of the content requested for resale through the DRM server; determining whether the use limitation of the content requested for resale is permitted to resale through the DRM server; registering the content for sale if the authentication information and use limitation of the content are valid for resale; requesting alteration of the authentication information of the registered content to the DRM server; receiving a response signal for the alteration of the authentication information of the content from the DRM server, wherein the response signal for the alteration of the authentication information of the content is transmitted by the DRM server which requests deletion of the authentication information of the content to the first computing device after receiving a signal of requesting alteration of the authentication information of the content from the used content server and receives a response signal for the deletion of the authentication information of the content transmitted by the first computing device having received the request information; receiving information of requesting purchase of the registered content from a second computing device; requesting alteration of the authentication information of the content to the DRM server; receiving a response for the alteration of the authentication information of the content from the DRM server; and reselling the content to the second computing device.

In a preferred embodiment, the resold content includes a Rights Object (RO) based on an Open Mobile Alliance (OMA) 2.0-based encryption method. Furthermore, the DRM server uses an OMA 2.0-based encryption method. Furthermore, the authentication information is RO information based on an OMA 2.0-based encryption method.

According to another aspect of the present invention, the present invention can provide a method of reselling authentication information in a used content server connected to a DRM server for managing authentication information of the content of at least one computing device, the method comprising the steps of receiving information of requesting resale of the authentication information from a first computing device; examining authentication information requested for resale through the DRM server; registering the authentication information for sale if the authentication information of the content is valid; requesting alteration of the authentication information registered for sale to the DRM server; receiving a response signal for the alteration of the authentication information from the DRM server, wherein the response signal for the alteration of the authentication information is transmitted by the DRM server which requests deletion of the authentication information to the first computing device after receiving a signal of requesting alteration of the authentication information from the used content server and receives a response signal for the deletion of the authentication information transmitted by the first computing device having received the request information; receiving information of requesting purchase of the registered authentication information from a second computing device; requesting alteration of the authentication information to the DRM server; receiving a response for the alteration of the authentication information from the DRM server; and reselling the authentication information to the second computing device.

In a preferred embodiment, the resold content includes a Rights Object (RO) based on an Open Mobile Alliance (OMA) 2.0-based encryption method. Furthermore, the DRM server uses an OMA 2.0-based encryption method. Furthermore, the authentication information is RO information based on an OMA 2.0-based encryption method.

According to another aspect of the present invention, the present invention can provide a method of reselling content in a used content server connected to at least one computing device, wherein the used content server is connected to a DRM server, the used content sold by the used content server includes authentication information authenticated by the DRM server, and the authentication information of the used content is updated by the DRM server when the used content is resold.

According to another aspect of the present invention, the present invention can provide a method of reselling authentication information in a used content server connected to at least one computing device, wherein the used content server is connected to a DRM server, authentication information sold by the used content server is authenticated by the DRM server, and the authentication information of the used content is updated by the DRM server when the authentication information is resold.

According to another aspect of the present invention, the present invention can provide a used content server configured to resell content and connected to a DRM server for managing authentication information of content of at least one computing device, the used content server comprising means for receiving information of requesting resale of the content from a first computing device; means for examining authentication information of the content requested for resale through the DRM server; means for registering the content for sale if the authentication information of the content is valid; means for receiving information of requesting purchase of the registered content from a second computing device; means for requesting alteration of the authentication information of the content to the DRM server; means for receiving a response signal for the alteration of the authentication information of the content from the DRM server, wherein the response signal for the alteration of the authentication information of the content is transmitted by the DRM server which requests deletion of the authentication information of the content to the first computing device after receiving a signal of requesting alteration of the authentication information of the content from the used content server and receives a response signal for the deletion of the authentication information of the content transmitted by the first computing device having received the request information; and means for reselling the content to the second computing device.

In a preferred embodiment, the resold content includes a Rights Object (RO) based on an OMA 2.0-based encryption method. Furthermore, the DRM server uses an OMA 2.0-based encryption method. Furthermore, the authentication information is RO information based on an OMA 2.0-based encryption method.

According to another aspect of the present invention, the present invention can provide a used content server configured to resell content having use limitation and connected to a DRM server for managing authentication information of content of at least one computing device, the used content server comprising means for receiving information of requesting resale of the content having use limitation from a first computing device; means for examining the authentication information of the content requested for resale through the DRM server; means for determining whether the use limitation of the content requested for resale is permitted to resale through the DRM server; means for registering the content for sale if the authentication information and use limitation of the content are valid for resale; means for requesting alteration of the authentication information of the registered content to the DRM server; means for receiving a response signal for the alteration of the authentication information of the content from the DRM server, wherein the response signal for the alteration of the authentication information of the content is transmitted by the DRM server which requests deletion of the authentication information of the content to the first computing device after receiving a signal of requesting alteration of the authentication information of the content from the used content server and receives a response signal for the deletion of the authentication information of the content transmitted by the first computing device having received the request information; means for receiving information of requesting purchase of the registered content from a second computing device; means for requesting alteration of the authentication information of the content to the DRM server; means for receiving a response for the alteration of the authentication information of the content from the DRM server; and means for reselling the content to the second computing device.

According to another aspect of the present invention, the present invention can provide a used content server configured to resell content having use limitation and connected to a DRM server for managing authentication information of the content of at least one computing device, the used content server comprising means for receiving information of requesting resale of the authentication information from a first computing device; means for examining authentication information requested for resale through the DRM server; means for registering the authentication information for sale if the authentication information of the content is valid; means for requesting alteration of the authentication information registered for sale to the DRM server; means for receiving a response signal for the alteration of the authentication information from the DRM server, wherein the response signal for the alteration of the authentication information is transmitted by the DRM server which requests deletion of the authentication information to the first computing device after receiving a signal of requesting alteration of the authentication information from the used content server and receives a response signal for the deletion of the authentication information transmitted by the first computing device having received the request information; means for receiving information of requesting purchase of the registered authentication information from a second computing device; means for requesting alteration of the authentication information to the DRM server; means for receiving a response for the alteration of the authentication information from the DRM server; and means for reselling the authentication information to the second computing device.

According to another aspect of the present invention, the present invention can provide a used content server connected to at least one computing device and configured to resell content, wherein the used content server is connected to a DRM server, the used content sold by the used content server includes authentication information authenticated by the DRM server, and the authentication information of the used content is updated by the DRM server when the used content is resold.

According to another aspect of the present invention, the present invention can provide a used content server connected to at least one computing device and configured to resell content, wherein the used content server is connected to a DRM server, authentication information sold by the used content server is authenticated by the DRM server, and the authentication information of the used content is updated by the DRM server when the authentication information is resold.

According to another aspect of the present invention, the present invention can provide an apparatus capable of performing operations, including memory, the apparatus comprising a processing unit; and a memory storage device connected to the processing unit; wherein the memory storage device is adapted to store a plurality of commands for receiving information of requesting resale of the content from a first computing device, examining authentication information of the content requested for resale through the DRM server, registering the content for sale if the authentication information of the content is valid, receiving purchase request information of the registered content from a second computing device, requesting alteration of the authentication information of the content to the DRM server, receiving a response signal for the alteration of the authentication information of the content from the DRM server, wherein the response signal for the alteration of the authentication information of the content is transmitted by the DRM server which requests deletion of the authentication information of the content to the first computing device after receiving a signal of requesting alteration of the authentication information of the content from the used content server and receives a response signal for the deletion of the authentication information of the content transmitted by the first computing device having received the request information, and reselling the content to the second computing device.

According to another aspect of the present invention, the present invention can provide an apparatus capable of performing operations, including memory, the apparatus comprising a processing unit; and a memory storage device connected to the processing unit; wherein the memory storage device is adapted to store a plurality of commands for receiving information of requesting resale of the content having use limitation from a first computing device, examining the authentication information of the content requested for resale through the DRM server, determining whether the use limitation of the content requested for resale is permitted to resale through the DRM server, registering the content for sale if the authentication information and use limitation of the content are valid for resale, requesting alteration of the authentication information of the registered content to the DRM server, receiving a response signal for the alteration of the authentication information of the content from the DRM server, wherein the response signal for the alteration of the authentication information of the content is transmitted by the DRM server which requests deletion of the authentication information of the content to the first computing device after receiving a signal of requesting alteration of the authentication information of the content from the used content server and receives a response signal for the deletion of the authentication information of the content transmitted by the first computing device having received the request information, receiving information of requesting purchase of the registered content from a second computing device, requesting alteration of the authentication information of the content to the DRM server, receiving a response for the alteration of the authentication information of the content from the DRM server, and reselling the content to the second computing device.

According to another aspect of the present invention, the present invention can provide an apparatus capable of performing operations, including memory, the apparatus comprising a processing unit; and a memory storage device connected to the processing unit; wherein the memory storage device is adapted to store a plurality of commands for receiving information of requesting resale of the authentication information from a first computing device, examining authentication information requested for resale through the DRM server, registering the authentication information for sale if the authentication information of the content is valid, requesting alteration of the authentication information registered for sale to the DRM server, receiving a response signal for the alteration of the authentication information from the DRM server, wherein the response signal for the alteration of the authentication information is transmitted by the DRM server which requests deletion of the authentication information to the first computing device after receiving a signal of requesting alteration of the authentication information from the used content server and receives a response signal for the deletion of the authentication information transmitted by the first computing device having received the request information, receiving information of requesting purchase of the registered authentication information from a second computing device, requesting alteration of the authentication information to the DRM server, receiving a response for the alteration of the authentication information from the DRM server, and reselling the authentication information to the second computing device.

### Advantageous Effects

According to the present invention, a method and apparatus for selling used content can be provided.

Furthermore, according to the present invention, a method and apparatus for reselling authentication information for the use of content and the content including the authentication information using Digital Right Management (DRM) can be provided.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a diagram illustrating the construction of a communication network for providing content, which includes a DRM server according to a preferred embodiment of the present invention;

FIG. 2 is a diagram schematically illustrating a method of reselling content using a used content server according to a preferred embodiment of the present invention;

FIG. 3 is a flowchart illustrating the order in which the used content server according to a preferred embodiment of the present invention resells used content having no use limitation;

FIG. 4 is a flowchart illustrating the sequence in which content having use limitation is resold according to a preferred embodiment of the present invention;

FIG. 5 is a flowchart illustrating the sequence in which a used content server according an embodiment of the present invention resells authentication information;

FIG. 6 is a flowchart illustrating the sequence in which content including authentication information having no limitation is resold according to a preferred embodiment of the present invention;

FIG. 7 is a flowchart illustrating a method of reselling content including authentication information having use limitation according to a preferred embodiment of the present invention; and

FIG. 8 is a flowchart illustrating a method of reselling only authentication information according a preferred embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

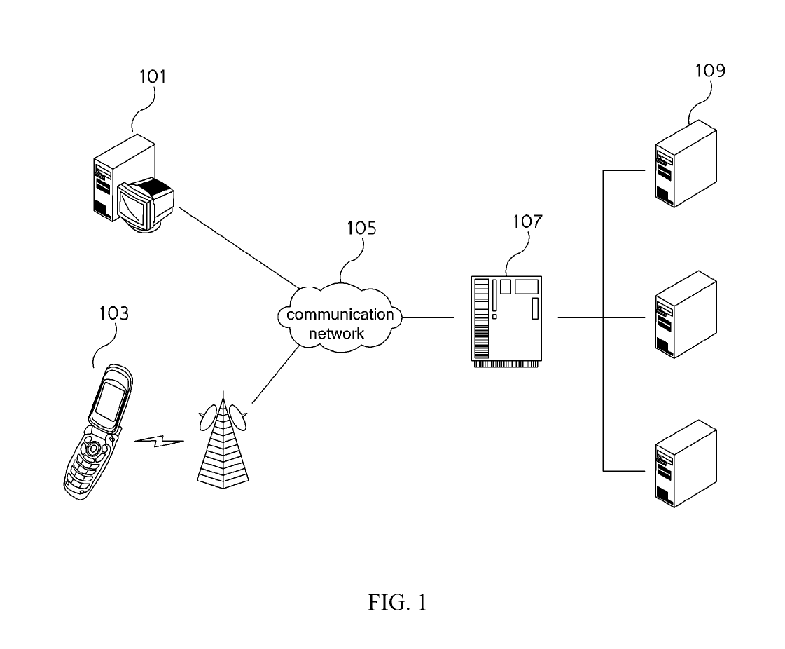

FIG. 1 is a diagram illustrating the construction of a communication network for providing content, which includes a DRM server according to a preferred embodiment of the present invention.

Referring to FIG. 1, user computing devices 101 and 103 may include general desktop computers and mobile terminals. Besides the desktop computer and the mobile terminal, any communicable computing devices capable of downloading content or receiving streamed content through a communication network can be used as the user computing devices 101 and 103.

A communication network 105 may be any type of communication network capable of delivering data or information, which includes a general mobile communication network or the Internet communication network. The user computing devices 101 and 103 can be connected to one end of the communication network.

A DRM server 107 is connected to one end of the communication network 105 and content provision servers 109 for providing content to the user computing devices 101 and 103. When the content servers 109 provide content to the user computing devices 101 and 103, the DRM server 107 functions to encrypt the content and generate authentication information ((Right Object (RO)) used for interpreting the encrypted content. Particularly, in the present invention, the encryption method provided by the DRM server may be based on Open Mobile Alliance (OMA) 2.0.

The encryption method based on the OMA 2.0 is a world-famous standard and is well-known by those skilled in the field of encryption, so that a detailed description thereof is omitted.

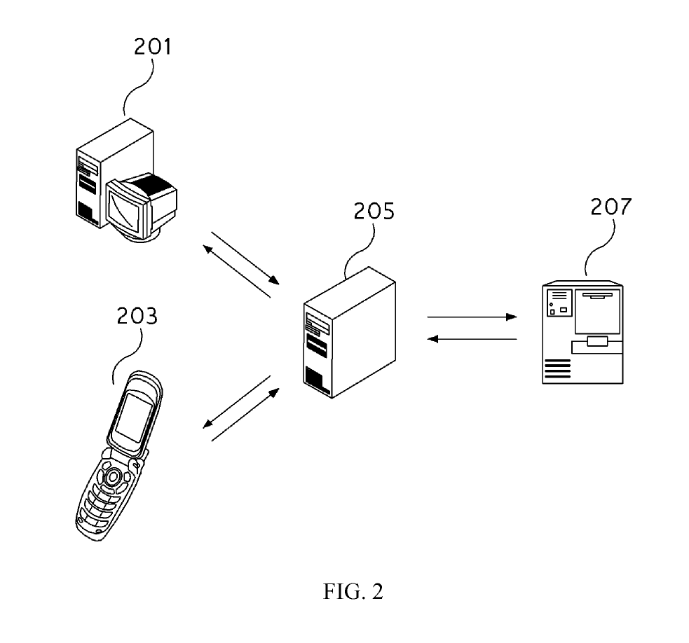

FIG. 2 is a schematic diagram illustrating a method of reselling content using a used content server according to a preferred embodiment of the present invention.

Referring to FIG. 2, first, when a seller's computing device 201 uses content previously purchased and determines that the utility of the content in the seller's computing device 201 is exhausted, the seller's computing device 201 requests the resale of the content to a used content server 205.

Then, the used content server 205, having received the request for the resale of the content, determines whether the content is valid through DRM server 207 connected to the used content server 205, and if the content is valid, then registers the content to be sell in the used content server. Then, a purchaser's computing device 203, which has checked information about the registered used content, requests the purchase of the content. The used content server 205, having received the purchase request, provides the used content to the purchaser's computing device, and provides remaining cost resulting from subtracting selling commission from purchase cost to the seller's computing device.

In order to make the resale of the used content possible as above mentioned, first, the content stored in the seller's computing device 201 should be authenticated by the DRM server 207 and has to contain authentication information. That is because If the content stored in the seller's computing device 201 does not have the correct information, endless copying of the digital content is possible because of the characteristics of the digital content, so that the meaning of selling used content disappears, therefore this may be a means for delivering illegally copied content. Therefore, the content stored in the seller's computing device 201 should include authentication information, or must be definitely authenticated by the DRM server 207 before the registration.

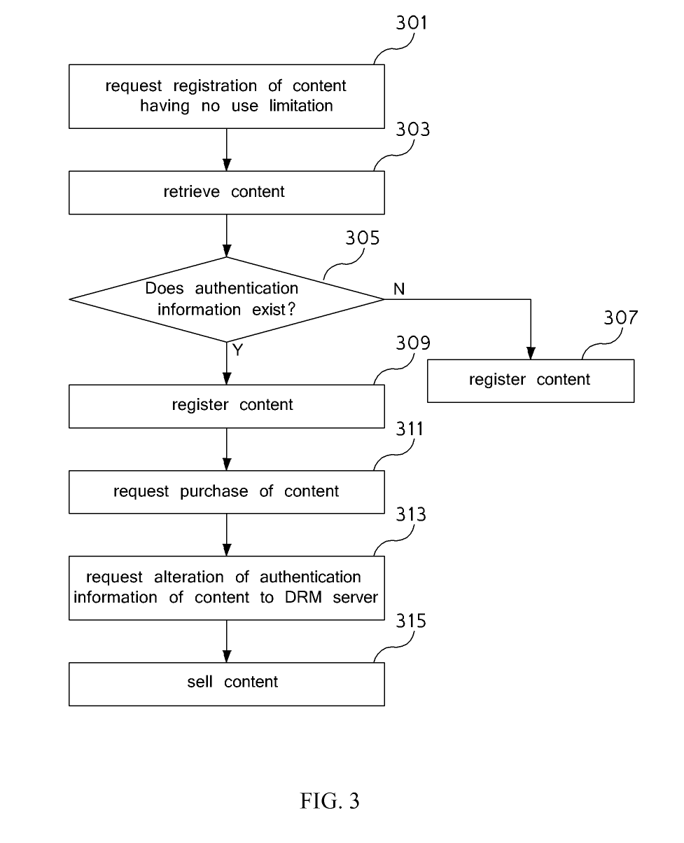

FIG. 3 is a flowchart illustrating the sequence in which the used content server according to a preferred embodiment of the present invention resells used content having no use limitation.

FIG. 3 relates to a method of reselling content having authentication information by which the content can be saled in the used content server and the authentication information can be used without the limitation of period and utility in a seller's computing device.

First, registration for the resale of the content is requested by the seller's computing device having content including limitless authentication information at step 301. Then, the used content server, having received the registration request, requests information about the content, requested for registration, to the DRM server at step 303. The DRM server to which the information is requested retrieves the authentication information of the content and informs the used content server of the retrieval result. Based on the retrieval result, the used content server determines whether appropriate authentication information is included in the content at step 305. If the appropriate authentication information is not included in the content, the registration of the content is refused at step 307. However, if the authentication information of the content is correct and valid, the content is registered in the used content server as an item for sale at step 309. Thereafter, in order to purchase the content registered as an item for sale, the purchaser's computing device requests the purchase of the content at step 311. If the purchase of the content is requested, the used content server requests the alteration of the authentication information of the content to the DRM server at step 313, and provides the content to the purchaser's computing device after the alteration of the authentication information at step 315.

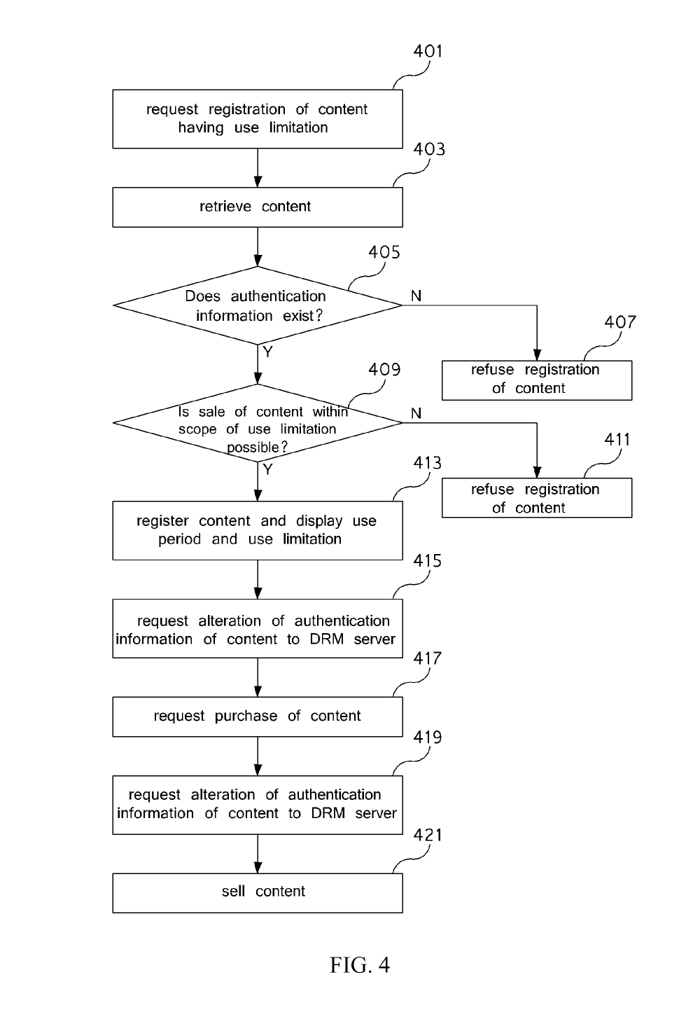

FIG. 4 is a flowchart illustrating the sequence in which content having use limitation is resold according to a preferred embodiment of the present invention.

FIG. 4 relates to a method of reselling content having authentication information by which the content can be saled in the used content server and the authentication information can be used with limitation of period and utility in a seller's computer.

First, registration for the resale of the content is requested by the seller's computing device having content including authentication information having limitations at step 401. Then, the used content server, having received the registration request, requests information about the content requested for registration to the DRM server at step 403. The DRM server to which the information is requested retrieves the authentication information of the content and informs the used content server of the retrieval result. Based on the retrieval result, the used content server determines whether appropriate authentication information is included in the content at step 405. If the appropriate authentication information is not included in the content, the registration of the content is refused at step 407. However, if the authentication information of content is correct and valid, it is determined whether the resale of the content is possible within the limitations of the authentication information of the content through the DRM server at step 409. If the resale of the content is impossible based on the use limitation of the content, the registration of the content is refused at step 410. If the resale of the content is possible in spite of the use limitation of the content, the content is registered in the used content server. The limitation of the authentication information, such as the use period and utility limitations of the content, is indicated at the same time of the registration of the content as an item for sale at step 411. Thereafter, the alteration of the authentication information of the registered content is requested to the DRM server. The reason for this is that, if the limitation of the authentication information relates to a time period, the period limitation of the authentication information needs to be stopped during the resale period and the possibility of being used in an original seller's computing device should be prevented (at step 413). Then, in order to purchase the content registered as an item for sale, the purchaser's computing device requests the purchase of the content at step 415. When the purchase of the content is requested, the used content server requests the alteration of the authentication information of the content to the DRM server at step 417, and provides the content to the purchaser's computing device after the alteration of the authentication information at step 419.

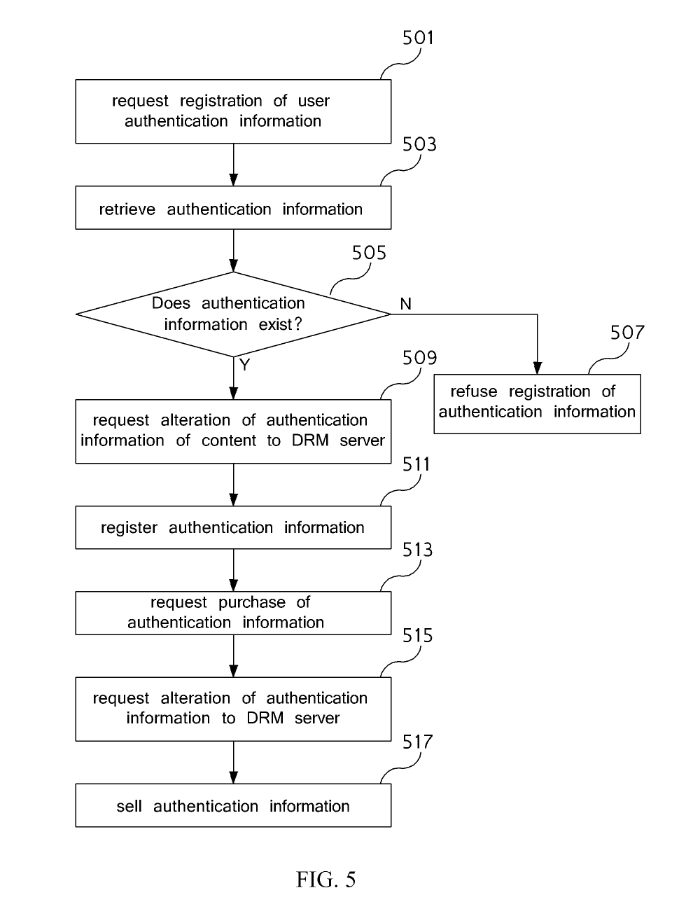

FIG. 5 is a flowchart illustrating the sequence in which a used content server according an embodiment of the present invention resells authentication information.

FIG. 5 relates to a method of separating authentication information from the content when the content itself is easily provided but the purchase of corresponding authentication information is difficult, and reselling it, and the content includes authentication information which can be saled in the used content server.

First, registration for the resale of authentication information is requested by the seller's computing device having the authentication information separable from the content at step 501. Then, the used content server, having received the registration request, requests information about the authentication information requested for the registration to the DRM server at step 503. The DRM server to which the information is requested retrieves the authentication information and informs the used content server of the retrieval result. Based on the retrieval result, the used content server determines whether the authentication information is appropriate at step 505. If the authentication information is not appropriate, the registration of the authentication information is refused at step 507. However, if the authentication information is correct and valid, the alteration of the authentication information is requested to the DRM server at step 509, and the authentication information is registered in the used content server as an item for sale at step 511. In this case, a request for the alteration of the authentication information is performed because the user information or period limitation information of the authentication information must be altered when the authentication information is registered in the used content server as an item for sale. Thereafter, in order to purchase the authentication information registered as an item for sale, the purchaser's computing device requests the purchase of the authentication information at step 513. When the purchase of the authentication information is requested, the used content server requests the alteration of the authentication information to the DRM server at step 515, and provides the content to the purchaser's computing device after the alteration of the authentication information at step 519.

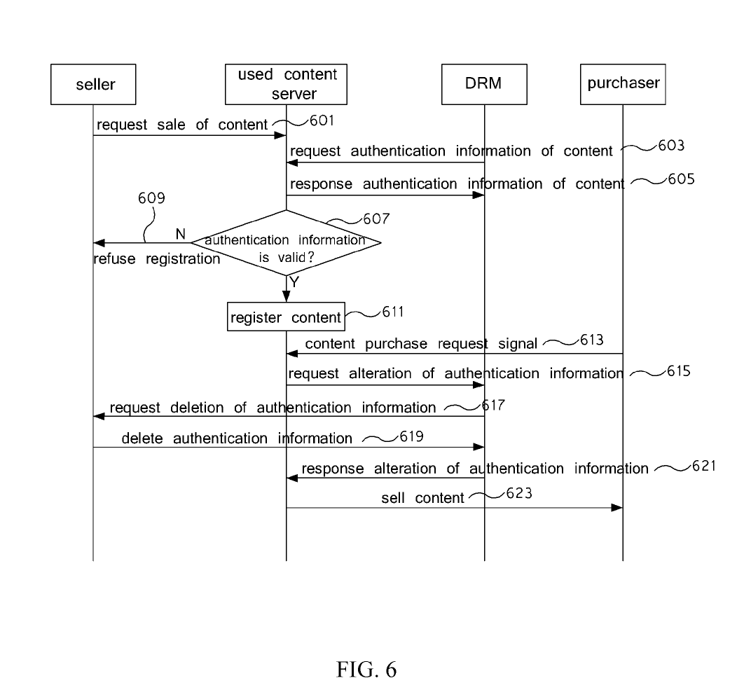

FIG. 6 is a flowchart illustrating the sequence in which content including authentication information having no limitation is resold according to a preferred embodiment of the present invention.

Referring to FIG. 6, first, the seller's computing device transmits a signal of requesting the resale of content including authentication information having no limitation to the used content server at step 601. Then, the used content server, having received the signal, requests examination for the authentication information of the requested content to the DRM server at step 603. The DRM server, having received the request, examines the authentication information included in the content and transmits examination results to the used content server at step 605. The used content server, having received the authentication information of the content, determines whether the authentication information received from the DRM server is valid at step 607. If the authentication information is not valid, the used content server transmits a signal refusing the registration to the seller's computing device at step 609, and, if the authentication information is valid, registers the content as an item for sale at step 611. Then, the seller's computing device, having retrieved information about the content registered as an item for sale, transmits a purchase request signal of requesting the purchase of the content to the used content server at step 613. Thereafter, the used content server, having received the purchase request signal, requests the alteration of the authentication information of the content registered for purchase to the DRM server at step 615. The DRM server, having received the request signal, transmits a signal of requesting the deletion of the authentication information to the seller's computing device in order to alter the authentication information at step 617. Then the use of content information existing in the seller's computing device is stopped, and, at the same time, the authentication information of the content is deleted and a response signal of the deletion is transmitted to the DRM server at step 619. Thereafter, the DRM server, having received the response signal of the deletion of the authentication information, alters the authentication information of the content and transmits the authentication information to the used content server at step 621. The used content server, having received the alteration signal of the authentication information, provides the content along with the altered authentication information, to the seller's computing device at step 623.

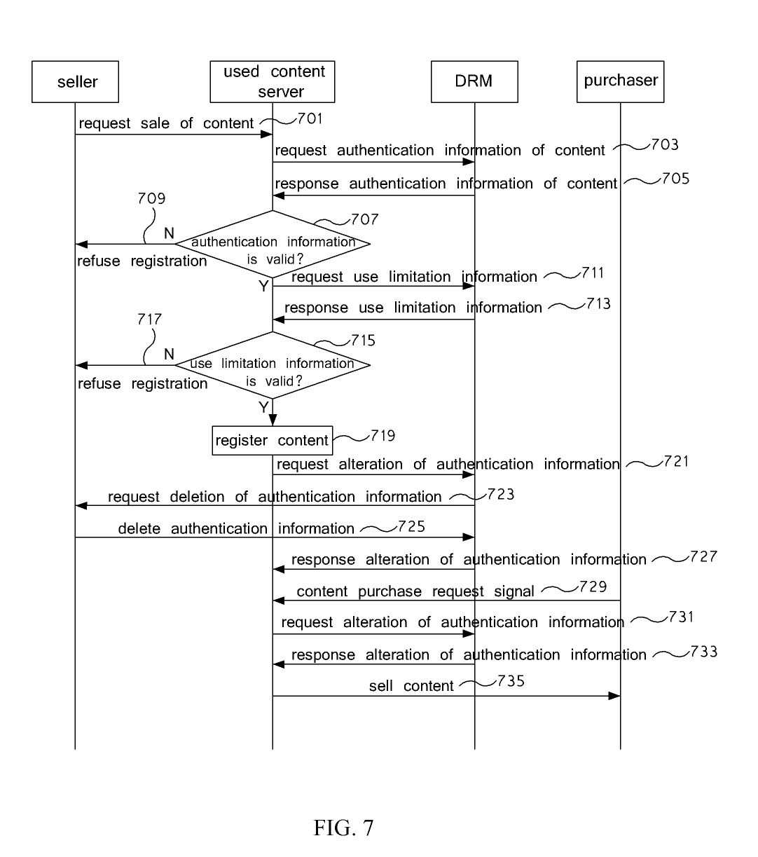

FIG. 7 is a flowchart illustrating a method of reselling content including authentication information having use limitation according to a preferred embodiment of the present invention.

Referring to FIG. 7, first, the seller's computing device transmits a signal of requesting the resale of content including authentication information having use limitation to the used content server at step 701. Then the used content server, having received the signal, requests examination of the authentication information of the requested content to the DRM server at step 703. The DRM server, having received the request signal, examines the authentication information included in the content and transmits the examination result to the used content server at step 705. The used content server, having received the authentication information of the content, determines whether the authentication information received from the DRM server is valid at step 707. If the authentication information is not valid, the used content server transmits a signal refusing the registration to the seller's computing device at step 709, and, if the authentication information is valid, requests examination of whether the resale of the authentication information is possible in spite of its use limitation to the DRM server at step 711. The DRM server, having received the signal of requesting the examination, examines use information again, and transmits use limitation information at step 713. The used content server, having received the use limitation information of the authentication information, analyzes the use limitation information, determines whether the resale of the content is possible in spite of the use limitation of the authentication information. If the resale of the content is impossible because of the use limitation, the used content server transmits a signal refusing the registration to the seller's computing device at step 717, and if the resale of the content is possible in spite of the use limitation, registers the content as an item for sale at step 719. After the registration of the content as an item for sale, the used content server requests the alteration of the authentication information to the DRM server at step 721. The DRM server, having received the request, transmits a signal of requesting the deletion of the authentication information to the seller's computing device in order to alter the authentication information at step 723. Then, the use of content information existing in the seller's computing device is stopped. At the same time, the authentication information of the content is deleted, and a response signal of the deletion is transmitted to the DRM server at step 725. Then, the DRM server, having received the response signal of the deletion of the authentication information, alters the authentication information of the content and transmits it to the used content server at step 727. Thereafter, the purchaser's computing device, having retrieved information about the content registered as an item for sale, transmits a purchase request signal of requesting the purchase of the content to the used content server at step 729. Then the used content server, having received the purchase request signal, requests the alteration of the authentication information of the content information requested for purchase to the DRM server at step 731. The DRM server, having received the request signal, alters the authentication information of the content and transmits it to the used content server at step 733. The used content server, having received the alteration signal of the authentication information, provides the content to the seller's computing device along with the altered authentication information at step 735.

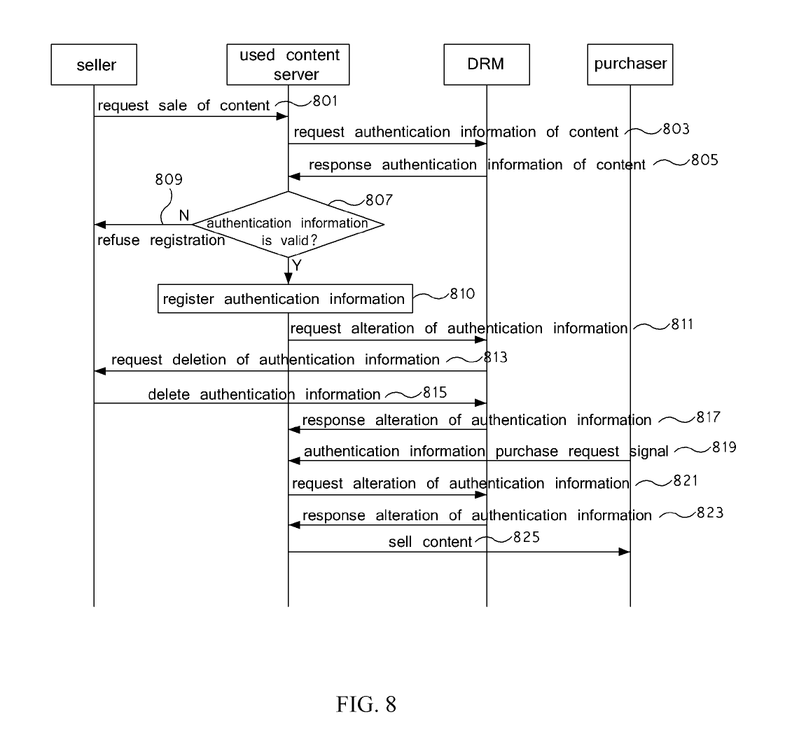

FIG. 8 is a flowchart illustrating a method of reselling authentication information only according a preferred embodiment of the present invention.

Referring to FIG. 8, first, the seller's computing device transmits a signal of requesting the resale of the authentication information to the used content server at step 801. Then the used content server, having received the signal, requests examination for the requested authentication information to the DRM server at step 803. The DRM server, having received the request signal, examines the authentication information, and transmits examination results to the used content server at step 805. The used content server, having received the authentication information of the content, determines whether the authentication information received from the DRM server is valid at step 807. If the authentication information is not valid, the used content server transmits a signal refusing the registration to the seller's computing device at step 809, and, if the authentication information is valid, registers the authentication information as an item for sale at step 810. After the registration of the authentication information as an item for sale, the used content server requests the alteration of the authentication information of the content to the DRM server at step 811. The DRM server, having received the request, transmits a signal of requesting the deletion of the authentication information to the seller's computing device in order to alter the authentication information of the content at step 813. Then, the use of content information existing in the seller's computing device is stopped. At the same time, the authentication information of the content is deleted and a response signal of the deletion is transmitted to the DRM server at step 815. Thereafter, the DRM server, having received the response signal of the deletion of the authentication information, alters the authentication information of the content and transmits it to the used content server at step 817. Then the purchaser's computing device, having retrieved the authentication information registered as an item for sale, transmits a purchase request signal of requesting the purchase of the authentication information to the used content server at step 819. Then, the used content server, having received the purchase request signal, requests the alteration of the authentication information requested for purchase to the DRM server at step 812. The DRM server, having received the request signal, alters the authentication information and transmits it to the used content server at step 823. The used content server, having received the alteration signal of the authentication information, provides the altered authentication information to the seller's computing device at step 825.

The present invention is not limited to the above-described embodiments, and various modifications may be made within the spirit of the invention by those skilled in the art.

We claim:

1. A method of reselling content in a used content server connected to a Digital Right Management (DRM) server for managing authentication information of content kept in each of at least one computing device, the method comprising the steps of:
receiving information of requesting resale of a content from a first computing device, wherein the content is authenticated by the DRM server in advance and kept in the first computing device;
examining whether authentication information of the content requested for resale is valid or not through the DRM server;
registering the content for sale if the authentication information of the content is valid;
receiving purchase request information of the registered content for sale from a second computing device;
requesting alteration of the authentication information of the content requested for purchase to the DRM server;
receiving a response signal for the alteration of the authentication information of the content from the DRM server, wherein the DRM server requests deletion of the authentication information of the content to the first computing device after having received a signal of requesting alteration of the authentication information of the content from the used content server, the first computing device having received the request for deletion of the authentication information of the content deletes the authentication information of the content and transmits a response signal for the deletion of the authentication information of the content to the DRM server and the DRM server transmits the response signal for the alteration of the authentication information of the content to the used content server; and
reselling the content to the second computing device.

2. The method as set forth in claim 1, wherein the resold content includes a Rights Object (RO) based on an Open Mobile Alliance (OMA) 2.0-based encryption method.

3. The method as set forth in claim 1, wherein the DRM server manages authentication information by using an OMA 2.0-based encryption method.

4. The method as set forth in claim 1, wherein the authentication information is RO information based on an OMA 2.0-based encryption method.

5. A method of reselling content in a used content server connected to a DRM server for managing authentication information of content kept in each of at least one computing device, the method comprising the steps of:
receiving information of requesting resale of a content having use limitation from a first computing device, wherein the content is authenticated by the DRM server in advance and kept in the first computing device;
examining whether the authentication information of the content requested for resale is valid or not through the DRM server;
determining whether the use limitation of the content requested for resale is permitted to resale through the DRM server;
registering the content for sale if the authentication information is valid and use limitation of the content is permitted to resale;
requesting alteration of the authentication information of the registered content to the DRM server;
receiving a response signal for the alteration of the authentication information of the content from the DRM server, wherein the DRM server requests deletion of the authentication information of the content to the first computing device after having received a signal of requesting alteration of the authentication information of the content from the used content server, the first computing device having received the request for deletion of the authentication information of the content deletes the authentication information of the content and transmits a response signal for the deletion of the authentication information of the content to the DRM server and the DRM server transmits the response signal for the alteration of the authentication information of the content to the used content server;
receiving purchase request information of the registered content for sale from a second computing device;
requesting alteration of the authentication information of the content to the DRM server;
receiving a response for the alteration of the authentication information of the content from the DRM server; and
reselling the content to the second computing device.

6. The method as set forth in claim 5, wherein the resold content includes a Rights Object (RO) based on an Open Mobile Alliance (OMA) 2.0-based encryption method.

7. The method as set forth in claim 5, wherein the DRM server manages authentication information by using an OMA 2.0-based encryption method.

8. The method as set forth in claim 5, wherein the authentication information is RO information based on an OMA 2.0-based encryption method.

9. A method of reselling authentication information in a used content server connected to a DRM server for managing authentication information of the content kept in each of at least one computing device, the method comprising the steps of:
receiving information of requesting resale of a content authentication information of from a first computing device, wherein the content is authenticated by the DRM server in advance and kept in the first computing device;
examining whether the content authentication information requested for resale is valid or not through the DRM server;
registering the content authentication information for sale if the content authentication information is valid;
requesting alteration of the content authentication information registered for sale to the DRM server;
receiving a response signal for the alteration of the content authentication information from the DRM server, wherein the DRM server requests deletion of the content authentication information to the first computing device after having received a signal of requesting alteration of the content authentication information from the used content server, the first computing device having received the request for deletion of the content authentication information deletes the content authentication information and transmits a response signal for the deletion of the content authentication information to the DRM server and the DRM server transmits the response signal for the alteration of the content authentication information to the used content server;
receiving purchase request information of the registered content authentication information from a second computing device;
requesting alteration of the content authentication information requested for purchase to the DRM server;
receiving a response for the alteration of the content authentication information from the DRM server; and
reselling the content authentication information to the second computing device.

10. The method as set forth in claim 9, wherein the resold content includes a Rights Object (RO) based on an Open Mobile Alliance (OMA) 2.0-based encryption method.

11. The method as set forth in claim 9, wherein the DRM server manages content authentication information by using an OMA 2.0-based encryption method.

12. The method as set forth in claim 9, wherein the DRM server uses an OMA 2.0-based encryption method.

13. A method of reselling content in a used content server connected to at least one computing device, wherein the used content server is connected to a DRM server, the used content sold by the used content server includes authentication information authenticated by the DRM server, and the authentication information of the used content is updated by the DRM server when the used content is resold to at least one of the computing device.

14. A method of reselling content authentication information in a used content server connected to at least one computing device, wherein the used content server is connected to a DRM server, the content authentication information sold by the used content server is authenticated by the DRM server, and the content authentication information is updated by the DRM server when the content authentication information is resold to at least one of the computing device.

15. A used content server for reselling content and connected to a DRM server for managing authentication information of content kept in each of at least one computing device, the used content server comprising:
means for receiving information of requesting resale of a content from a first computing device, wherein the content is authenticated by the DRM server in advance and kept in the first computing device;
means for examining whether authentication information of the content requested for resale is valid or not through the DRM server; means for registering the content for sale if the authentication information of the content is valid;
means for receiving purchase request information of the registered content for sale from a second computing device;
means for requesting alteration of the authentication information of the content requested for purchase to the DRM server;
means for receiving a response signal for the alteration of the authentication information of the content from the DRM server, wherein the DRM server requests deletion of the authentication information of the content to the first computing device after having received a signal of requesting alteration of the authentication information of the content from the used content server, the first computing device having received the request for deletion of the authentication information of the content deletes the authentication information of the content and transmits a response signal for the deletion of the authentication information of the content to the DRM server and the DRM server transmits the response signal for the alteration of the authentication information of the content to the used content server; and
means for reselling the content to the second computing device.

16. The used content server as set forth in claim 15, wherein the resold content includes a Rights Object (RO) based on an OMA 2.0-based encryption method.

17. The used content server as set forth in claim 15, wherein the DRM server manages authentication information by using an OMA 2.0-based encryption method.

18. The used content server as set forth in claim 15, wherein the authentication information is RO information based on an OMA 2.0-based encryption method.

19. A used content server for reselling content having use limitation and connected to a DRM server for managing authentication information of content kept in each of at least one computing device, the used content server comprising:
means for receiving information of requesting resale of a content having use limitation from a first computing device, wherein the content is authenticated by the DRM server in advance and kept in the first computing device;
means for examining whether the authentication information of the content requested for resale is valid or not through the DRM server;
means for determining whether the use limitation of the content requested for resale is permitted to resale through the DRM server;
means for registering the content for sale if the authentication information is valid and use limitation of the content is permitted to resale;
means for requesting alteration of the authentication information of the registered content to the DRM server;
means for receiving a response signal for the alteration of the authentication information of the content from the DRM server, wherein the DRM server requests deletion of the authentication information of the content to the first computing device after having received a signal of requesting alteration of the authentication information of the content from the used content server, the first computing device having received the request for deletion of the authentication information of the content deletes the authentication information of the content and transmits a response signal for the deletion of the authentication information of the content to the DRM server and the DRM server transmits the response signal for the alteration of the authentication information of the content to the used content server;
means for receiving purchase request information of the registered content for sale from a second computing device;
means for requesting alteration of the authentication information of the content to the DRM server;
means for receiving a response for the alteration of the authentication information of the content from the DRM server; and
means for reselling the content to the second computing device.

20. A used content server for reselling content authentication information and connected to a DRM server for managing authentication information of the content kept in each of at least one computing device, the used content server comprising:
means for receiving information of requesting resale of a content authentication information of from a first computing device, wherein the content is authenticated by the DRM server in advance and kept in the first computing device;
means for examining whether the content authentication information requested for resale is valid or not through the DRM server;
means for registering the content authentication information for sale if the content authentication information is valid;
means for requesting alteration of the content authentication information registered for sale to the DRM server;
means for receiving a response signal for the alteration of the content authentication information from the DRM server, wherein the DRM server requests deletion of the content authentication information to the first computing device after having received a signal of requesting alteration of the content authentication information from the used content server, the first computing device having received the request for deletion of the content authentication information deletes the content authentication information and transmits a response signal for the deletion of the content authentication information to the DRM server and the DRM server transmits the response signal for the alteration of the content authentication information to the used content server;
means for receiving purchase request information of the registered content authentication information from a second computing device;
means for requesting alteration of the content authentication information requested for purchase to the DRM server;
means for receiving a response for the alteration of the content authentication information from the DRM server; and
means for reselling the content authentication information to the second computing device.

21. A used content server connected to at least one computing device and for reselling content, wherein the used content server is connected to a DRM server, the used content sold by the used content server includes authentication information authenticated by the DRM server, and the authentication information of the used content is updated by the DRM server when the used content is resold to at least one of the computing device.

22. A used content server connected to at least one computing device and configured for reselling content, wherein the used content server is connected to a DRM server, the content authentication information sold by the used content server is authenticated by the DRM server, and the content authentication information is updated by the DRM server when the content authentication information is resold to at least one of the computing device.

23. An apparatus capable of performing operations, including memory, the apparatus comprising:
a processing unit; and
a memory storage device connected to the processing unit;
wherein the memory storage device is adapted to store a plurality of commands for receiving information of requesting resale of a content from a first computing device, wherein the content is authenticated by the DRM server in advance and kept in the first computing device, examining whether authentication information of the content requested for resale is valid or not through the DRM server, registering the content for sale if the authentication information of the content is valid, receiving purchase request information of the registered content for sale from a second computing device, requesting alteration of the authentication in formation of the content requested for purchase to the DRM server, receiving a response signal for the alteration of the authentication information of the content from the DRM server, wherein the DRM server requests deletion of the authentication information of the content to the first computing device after having received a signal of requesting alteration of the authentication information of the content from the used content server, the first computing device having received the request for deletion of the authentication information of the content deletes the authentication information of the content and transmits a response signal for the deletion of the authentication information of the content to the DRM server and the DRM server transmits the response signal for the alteration of the authentication information of the content to the used content server and reselling the content to the second computing device.

24. An apparatus capable of performing operations, including memory, the apparatus comprising:
a processing unit; and
a memory storage device connected to the processing unit;
wherein the memory storage device is adapted to store a plurality of commands for receiving information of requesting resale of a content having use limitation from a first computing device, wherein the content is authenticated by the DRM server in advance and kept in the first computing device, examining whether the authentication information of the content requested for resale is valid or not through the DRM server, determining whether the use limitation of the content requested for resale is permitted to resale through the DRM server, registering the content for sale if the authentication information is valid and use limitation of the content is permitted to resale, requesting alteration of the authentication information of the registered content to the DRM server, receiving a response signal for the alteration of the authentication information of the content from the DRM server, wherein the DRM server requests deletion of the authentication information of the content to the first computing device after having received a signal of requesting alteration of the authentication information of the content from the used content server, the first computing device having received the request for deletion of the authentication information of the content deletes the authentication information of the content and transmits a response signal for the deletion of the authentication information of the content to the DRM server and the DRM server transmits the response signal for the alteration of the authentication information of the content to the used content server, receiving purchase request information of the registered content for sale from a second computing device, requesting alteration of the authentication information of the content to the DRM server, receiving a response for the alteration of the authentication information of the content from the DRM server and reselling the content to the second computing device.

25. An apparatus capable of performing operations, including memory, the apparatus comprising:
a processing unit; and
a memory storage device connected to the processing unit;
wherein the memory storage device is adapted to store a plurality of commands for receiving information of requesting resale of a content authentication information of from a first computing device, wherein the content is authenticated by the DRM server in advance and kept in the first computing device, examining whether the content authentication information requested for resale is valid or not through the DRM server, registering the content authentication information for sale if the content authentication information is valid, requesting alteration of the content authentication information registered for sale to the DRM server, receiving a response signal for the alteration of the content authentication information from the DRM server, wherein the DRM server requests deletion of the content authentication information to the first computing device after having received a signal of requesting alteration of the content authentication information from the used content server, the first computing device having received the request for deletion of the content authentication information deletes the content authentication information and transmits a response signal for the deletion of the content authentication information to the DRM server and the DRM server transmits the response signal for the alteration of the content authentication information to the used content server, receiving purchase request information of the registered content authentication information from a second computing device, requesting alteration of the content authentication information requested for purchase to the DRM server, receiving a response for the alteration of the content authentication information from the DRM server and reselling the content authentication information to the second computing device.
